(19) United States
(12) Patent Application Publication
(10) Pub. No.: US 2025/0336993 A1
(43) Pub. Date: Oct. 30, 2025

(54) Flow Battery Measurement System

(71) Applicant: Southwest Research Institute, San Antonio, TX (US)

(72) Inventors: Bapiraju SURAMPUDI, San Antonio, TX (US); Jayant SARLASHKAR, San Antonio, TX (US)

(21) Appl. No.: 18/645,840

(22) Filed: Apr. 25, 2024

(51) Int. Cl. H01M 8/04537; H01M 8/18

(52) U.S. Cl. CPC H01M 8/04611; H01M 8/188

(57) ABSTRACT

A flow battery measurement system for determination of one of state of health and state of charge of a flow battery. The system includes fiber optics deployed through one or more chambers of a flow battery for acquisition of fiber optic data therefrom. A prism is utilized to ensure that the collected fiber optic data is obtained in a direction that is opposite the manner in which fiber optic light has been transmitted over a fiber optic line into the chamber. Thus, flowing of fluids through the chambers may occur in a manner that does not compromise the obtained fiber optic data. Acquisition of the data may occur from multiple chambers and/or multiple chamber depths through the use of multiple prisms.

### BACKGROUND

It is becoming increasingly common for the powering of commercial, industrial and personal use equipment to be supplemented or supported by the use of flow batteries. Currently, flow batteries are often available in large, multi-square foot form factors and may be found in sizes similar to a personal use home generator. However, flow battery technology is readily scalable such that larger flow batteries are often provided that are closer to shipping container sizes that are utilized in conjunction with power grids for supplementation. Of course, a variety of other flow battery sizing and application options are also available.

Scalability of flow batteries is a significant benefit that may be provided. Additionally, they may be less prone to fire and other hazards. For example, the materials utilized to support flow battery operation are often less volatile and/or toxic. Thus, leakage during use may take place without substantial risk to personal users and operators. This means that manufacturing risks may also be kept to a minimum without incurring significant costs. Yet, in spite of these advantages, flow batteries remain largely underutilized.

A flow battery is a system that includes a membrane interface that is fluidly linked to two separate fluid containers. In one container, a fluid serving as an anolyte is provided. In the other container, a catholyte is found. Each fluid is independently circulated toward the membrane interface where a reaction takes place which may support the ultimate power supply to be made available. This fluid circulation also includes returning the reacted fluid from the membrane interface and back to its original container. Ideally, this concept would result in a near endless supply of energy from the flow battery so long as the circulation of each fluid from each tank, to the membrane interface, and back again, were provided. Of course, in reality, this is not the case.

Flow battery fluids are subject to the same state of health (SOH) concerns as other employed industrial fluids such as the development of impurities, turbidity and other use related factors. Further, with the need for each fluid to serve either a cathode or anode function, changing electrolyte properties over the use period can also impact performance or the state of charge (SOC) for the battery. Thus, like with a conventional solid-electrode battery, over time, the flow battery will eventually suffer losses and no longer hold the same level of charge.

Unfortunately, at present, determining the SOC or SOH for a flow battery with any degree of accuracy is a challenge. That is, while determining the real-time output of a flow battery is possible prior to or during use, a secondary or redundant read of the condition of the flow battery fluids is presently unavailable. As a result, prior to use, precise determinations of the charge level, fluid condition or remaining life are not realistic. Rather, fluids, battery fluid containers, or entire flow batteries are most likely changed out at regular intervals largely based on guesswork rather than based on the condition.

Changing out fluids at predetermined intervals without an accurate read of the actual SOC or SOH conditions presents issues in and of itself. For example, the likelihood of premature change out means that there is a likelihood of added expense for replacement fluids or components that is not warranted in reality. Further, the likelihood of waiting too long for such replacement means that inefficient flow battery performance may be occurring until the next scheduled time for replacement. As a practical matter, operators are left with the unenviable choice between costs losses due to unnecessary changeouts, inefficient operation or simply avoiding flow battery use altogether due to such uncertainties.

### SUMMARY

A system for monitoring flow battery conditions such as state of charge and state of health of a flow battery. The system includes a flow battery with an anode chamber housing an anolyte fluid and a cathode chamber housing a catholyte fluid. A transmitter is coupled to one end of one of the chambers with a fiber optic line coupled thereto and suspended through one of the fluids. A prism is located at the opposite end of the pertinent chamber for directing a transmitted light through the line from the transmitter and back toward the transmitter end of the chamber. Thus, a fiber optic reading of the fluid may be attained. Further, the reading may be obtained in a manner consistent with the fluid being circulated in a given direction through the chamber.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a side schematic view of an embodiment of a fiber optic line assembly for suspension through a fluid chamber of a flow battery.

FIG. 2 is a schematic view of an embodiment of a flow battery measurement system employing the fiber optic line assembly of FIG. 1.

FIG. 3A is a schematic overview of the system of FIG. 2 within an arrangement for monitoring conditions of a flow battery.

FIG. 3B is a chart depicting an embodiment of a flow battery condition in terms of light intensity based on monitored light with the system of FIG. 2.

FIG. 4 is a side schematic view of an embodiment of the fiber optic line assembly of FIG. 1 employing a plurality of prisms.

FIG. 5 is a flow-chart summarizing an embodiment of employing a fiber optic line assembly for determinations of a flow battery condition.

### DETAILED DESCRIPTION

Embodiments are described with reference to particular flow battery measurement system arrangements. Specifically, the embodiments depict a layout that includes a particular manner of employing a fiber optic line assembly for deployment through a fluid chamber of a flow battery. However, other layouts may be utilized. For example, while a prism is utilized for routing light back toward a light source, multiple prisms and/or various prism architectures may be utilized. Regardless, so long as the layout includes a manner of routing light through the submerged fiber optic within the fluid of the chamber and back, appreciable benefit may be realized.

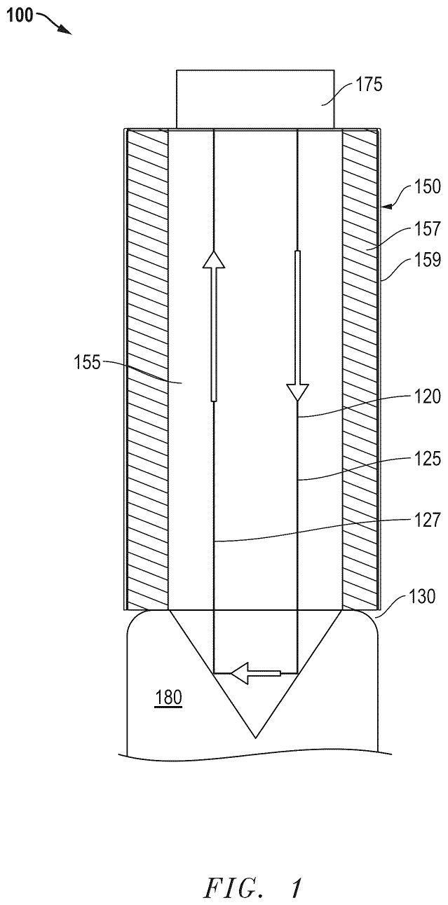

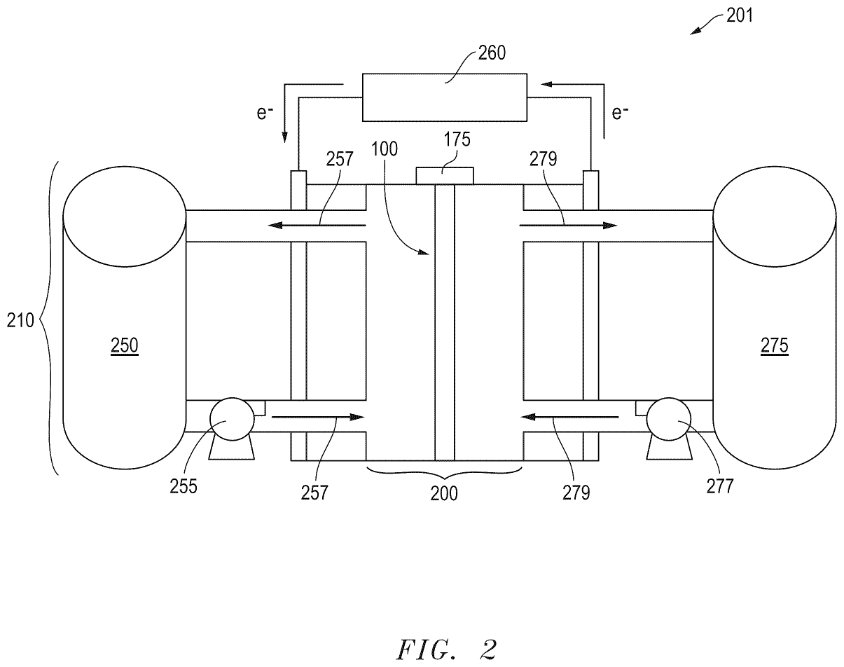

Referring now to FIG. 1, a side schematic view of an embodiment of a fiber optic line assembly 100 is shown. With added reference to FIG. 2, this assembly 100 is configured for suspension through a fluid chamber 200, 250, 275 of a flow battery 210. That is, the flow battery 210 may include an anode chamber 250, a cathode chamber 275 and a membrane interface chamber 200. Each of these chambers 200, 250, 275 may include a fluid or fluid mixture from which fiber optic reading may be acquired as detailed further below.

Continuing with reference to FIG. 1, the assembly 100 itself includes a fiber optic line 150 with a core 155 that is surrounded by conventional jacketing layers 157, 159. The line 150 is coupled to a transmitter and receiver device 175 for routing fiber optic light 120 through the line 150 along an emission path 125 for return and collection from a return path 127. Of course, the device 175 may be a part of a single transceiver or provided as separate light emission and collection devices.

Of note with the embodiment of FIG. 1 is the presence of a prism 180. The prism 180 is provided as a manner of ensuring that the light 120 which is transmitted through the line from the device 175 is returned. That is, rather than collecting data from the light 120 at the terminal end of the line 150, the light 120 is returned for collection and analysis. As described further below, this manner of routing the light 120 is unique in the instance of a flow battery 210 where fluid of the chambers 200, 250, 275 is circulated (see FIG. 2). This is because with the fluid adjacent the assembly 100 being flowed in a given direction (e.g. bottom to top as shown), the opportunity to analyze collected light data in a more accurately enhanced manner is provided.

With respect to the prism 180, a certain degree of exposure 130 is presented to the fluid of the chamber 200, 250, 275 and a particular angle of reflection 135 is utilized to return the emitted light 125 back toward the source (see 127). As a result, the light 120 travels in two opposite directions, one down 120 and one up 127. Of course, depending on chamber architecture, these directions may be referred to differently. Regardless, as detailed further below, with added reference to FIG. 2, so long as these directions are opposite one another, readings acquired from the line 150 through a circulating fluid may more be of enhanced accuracy. That is, as opposed to light readings that may be affected by a circulating flow when only sent in a single direction, sending the light 120 both with and against the flow as described below may provide a more reliably accurate detection.

The architecture of the prism 180, including the angle at which the sent light 120 interfaces the prism 180 prior to return 127 are selected in a manner that facilitates a total internal reflection as depicted. Thus, a reference condition may be established based on prism architecture, materials and those of the electrolyte 130 to which the prism 180 is exposed. Thus, the return light 127 may provide a reading based on the referenced condition such as battery “full” or “depleted” depending on return light readings based on detected electrolyte 130 condition.

From an optics standpoint, total internal reflection occurs when certain well known criterion between the angle of incidence, the angle of reflection, and the ratio of the refractive indices of the two materials, in this case, prism 180 and electrolyte 130, are met. The refractive index and color of any material such as the electrolyte 130 are intrinsically related. Therefore, as the battery 210 of FIG. 2 charges or discharges, the color or refractive index changes accordingly. This results in reduced reflection at the boundary between the prism 180 and the electrolyte 130 may correspondingly be determined by the transceiver 175 and associated components as described below.

From an operator standpoint, where a flow battery 210 as shown in FIG. 2 is at issue, color change over the course of depletion may appear to be changing from a dark blue to bright yellow. This is a change in wavelength from about 600 nm to about 450 nm. In one embodiment, this quantifiable change may be determined by the added use of multiple color sensors, e.g. red, green, blue (RGB) at the receiver 175. Using the RGB values measured, a determination of the color of the electrolyte 130 may be established due to the refractive index of the electrolyte.

The above example is directed at determining the SOC. However, additional information regarding the state of the battery 210 of FIG. 2 is also available. For example, slower optical effects due to impurities within the electrolyte 130 and other detectable conditions may also reflect the SOH of the battery 210 as detailed further below. Additionally, temperature conditions, also determinable by the fiber optic line 150, may be taken into account either in a cumulative sense or as a matter of calibration for the readings being acquired.

Referring now to FIG. 2 more specifically, a schematic view of an embodiment of a flow battery measurement system 201 is illustrated. In this depiction, a flow battery 210 is illustrated that is utilized with the fiber optic line assembly 100 of FIG. 1. The flow battery 210 itself includes discrete tanks or containers 250, 275. These containers 250, 275 are constructed for securely housing a fluid that is either an anolyte 250 or a catholyte 275. For example, in one embodiment, the anolyte container 250 houses a titanium salt dissolved in an acid, whereas the catholyte container 275 houses a cerium salt dissolved in an acid. Of course, a variety of other material options may be available which are well suited for liquid flow in a manner that facilitates electrolyte interaction at a membrane interface 200 as shown.

For the embodiment of FIG. 2, the membrane interface 200 is illustrated as another chamber or container where the described anolyte and catholyte are brought into proximity during a controlled flow or circulation. Specifically, notice the fluid pump devices 255, 277 which facilitate a circulation 257, 279 of the fluids toward one another at the interface 200 before return to their respective containers 250, 275. Thus, it is within this membrane interface 200 where an ionic interaction is facilitated which ultimately serves as the electrical output available from the battery 210.

In keeping the anolyte and catholyte fluids separate, the membrane interface 200 may constitute a porous carbon electrode or other suitable structure to facilitate an ionic circulation of fluid and electrical interaction without promotion of a more complete fluid mixing of the anolyte and catholyte fluids. For the embodiment illustrated, the fiber optic line assembly 100 of FIG. 1 is also located within this interface 200 where a more discrete membrane separation structure may also be located.

For alternate embodiments, the assembly 100 may instead be disposed in either container 250, 275 for acquiring of more anolyte or catholyte specific readings therefrom. For such embodiments, readings acquired from one container 250, 275 over the course of battery operation may be indicative of fluid characteristics of the given container 250, 275. Additionally, these readings may also be extrapolated for indications relative to the other container due to the inherent dependency of each container's fluid characteristics on the other over the course of battery operation. Furthermore, where warranted, a plurality of the described assemblies 100 may be utilized, for example, within each of, or any of, the containers 250, 275, 200. In this way, multiple readings may be acquired for combined analysis of the SOC and/or SOH of the battery 210.

Continuing with reference to FIG. 2, while illustrated in schematic form, notice that the ionic charging capacity (e) available from the battery 210 is routed to a power source 260 for storage and use. As the battery 210 is utilized over time, the described system 201 has been provided such that the SOC and SOH of the battery 210 may be monitored in a reliable fashion. That is, while a continuous circulation of such fluids would ideally supply charge and remain in ample health indefinitely, this is invariably not a reality. Thus, a true measure of these characteristics may be provided so as to maximize the full potential of such batteries 210 in a more realistic manner so as to avoid unnecessary discarding or overuse.

Recall that the acquired measurements from the assembly 100 may relate to fluid characteristics such as color or temperature which may be correlated to determining the SOC. However, coloring may also be indicative of a state of fluid health (SOH) over time as impurities, bubbles or other developments emerge over the course of battery usage as described further below. For example, hydrogen bubbling, which can lead to turbidity, often develops over time with vanadium and other similar flow batteries.

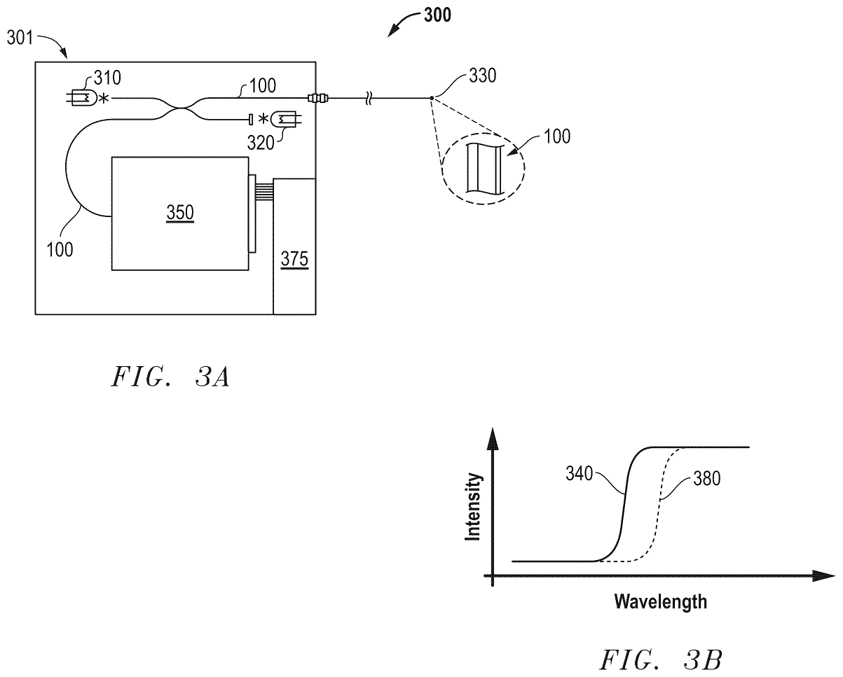

Referring now to FIG. 3A, a schematic overview of the line assembly 100 for the system 201 of FIG. 2 is illustrated. More specifically, the assembly 100 is shown within a broader overview arrangement 300 for monitoring conditions of a flow battery 210 as illustrated in FIG. 2. The arrangement 300 includes a signal conditioner assembly 301 for obtaining and managing light data from the fiber optic line assembly 100 as described above.

The fiber optic line assembly 100 is configured for obtaining and returning light as described above. More specifically, the returned light is routed to an optical sensor 330 for transmission of the return light data to the conditioner assembly 301. Ultimately, this data may be received at an optical spectrum analyzer 350 and processed at a signal processing unit 375 as shown. Once processed, the data may provide SOC and SOH information regarding battery conditions. In one embodiment, the analyzer 350 may operate at a sampling rate of between about 75 and 125 Hz, depending on the parameters of the application. For example, flow rates, temperatures, materials or even the sought level of accuracy may be factors in determining a variety of operating conditions for the analyzer 350 and overall arrangement 300.

Continuing with reference to FIG. 3A, notice that the fiber optic line assembly 100 continues past the optical sensor 330 to provide the fiber optic data as described above. More specifically, in the layout of the conditioner assembly 301, fiber optics are utilized to obtain the initially transmitted light from a light source 310 toward the sensor 330. However, a reference light 320 is also provided. In this way, variations between the initially transmitted light and the returned fiber optic data described above may be accounted for by the analyzer 350 and the processing unit 375 in a more calibrated, real-time manner.

Referring now to FIG. 3B, a chart depicting an embodiment of a flow battery condition in terms of light intensity based on monitored light as described above is shown. Of course, these results are only exemplary and not necessarily indicative of any particular specific flow battery condition. So, for example, even for a relatively new and/or uncompromised flow battery of expected performance, a reference chart may be established. Where this is the circumstance for the chart of FIG. 3B, notice the correlation between light intensity as transmitted plotted against detection wavelengths. So, for example, regardless of units for either, an initial expected plot 340 may be attained for reference over the course of monitoring as described above. However, notice the adjusted plot 380 which may also be as expected where another temperature is at issue. As an exemplary only, plots 340, 380 for a conventional vanadium flow battery may initially appear as shown with wavelengths over about 550 nm which appear dark blue. However, as turbidity or other issues develop, this may change to a more bright yellow with wavelengths below about 500 nm. That is, where either of these plots 340, 380 is developed in a manner where varying conditions have emerged such as the development of impurities, turbidity as noted, the depletion of electrolyte or other factors, this may also be reflected in measurably different plots than those illustrated in FIG. 3B (e.g. 340, 380). Through the use of reference data such as the chart of FIG. 3B, acquired results from the arrangement 300 of FIG. 3A may be plotted or otherwise utilized to help establish both SOH and SOC for a given battery condition.

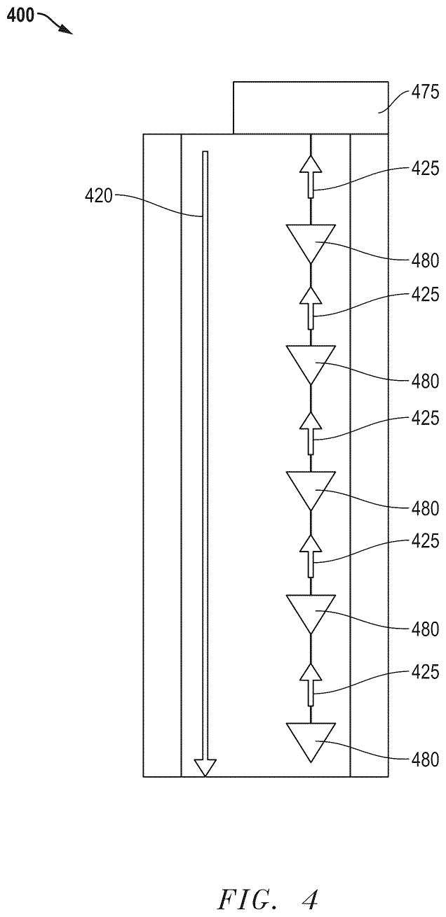

Referring now to FIG. 4, a side schematic view of an embodiment of the fiber optic line assembly 400 of FIG. 1 is shown employing a plurality of prisms 480. For this particular embodiment, the assembly 400 is constructed in a manner that takes into account the fact that electrolyte depletion, turbidity and other conditions may present in different manners to a given fluid. This may include different electrolyte, impurity or even bubble concentrations at different levels of any given chamber 200, 250, 275, particularly where larger and larger chambers 200, 250, 275 are utilized (see FIG. 2). Therefore, given that the prisms 480 (in the instance of FIG. 4), are the locations of return light paths (e.g. see 425) from the initially transmitted light 420, different light data is available depending on the depth of any given prism 480. Thus, the transmitter and/or receiver device 475 is provided with additional light data for ultimate acquisition of a more overall enhanced and representative data set related to the measured fluids.

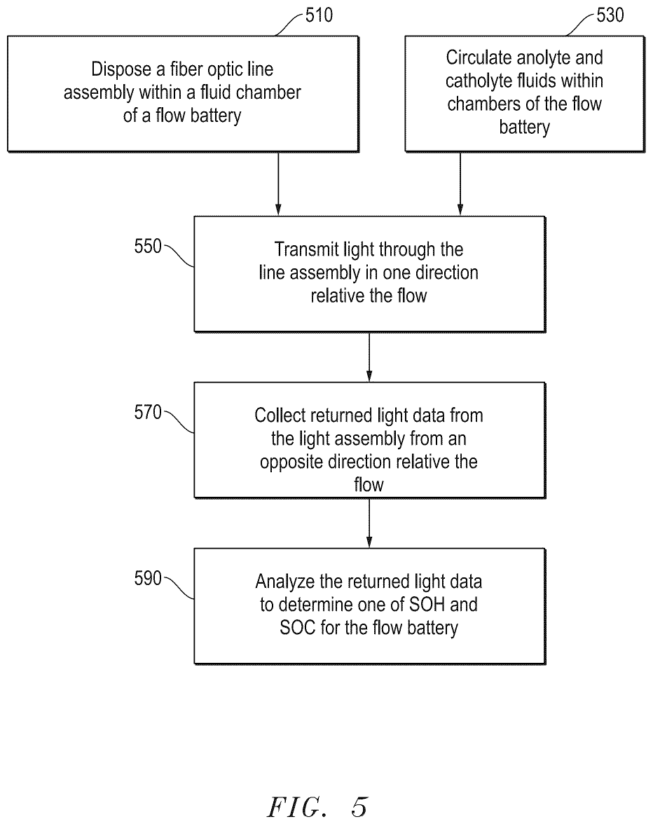

Referring now to FIG. 5, a flow-chart summarizing an embodiment of employing a fiber optic line assembly for determinations of a flow battery condition is shown. Specifically, a fiber optic line assembly is disposed of within a fluid chamber of a flow battery as noted at 510. As indicated at 530, fluid within flow battery chambers is circulated. This includes the fluid chamber with the line assembly.

With the flow battery equipped with the line assembly, light may be transmitted through fiber optics of the assembly (see 550). This transmission may be with or against the direction of flow for the circulating fluid. Regardless, as noted at 570, the light may be returned and collected back toward the direction of the source. Thus, the collected light data is obtained from an opposite direction of the initially transmitted light. As indicated at 590, the collected light data is now available for analysis to determine state of health or charge condition for the battery.

Embodiments described hereinabove include a system and techniques for acquiring accurate, real-time health and charge information for a flow battery. This is particularly beneficial for avoiding costly premature changeout of flow batteries or flow battery fluids. Furthermore, this also helps avoid overuse and reliance on inefficiently operating flow batteries. Thus, a wider acceptable adoption of flow batteries may be accommodated. The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A flow battery measurement system comprising:
an anode chamber of a flow battery containing an anolyte fluid;
a cathode chamber of a flow battery containing a catholyte fluid;
a membrane chamber for fluid communication with the anode and cathode chambers;
a fiber optic line deployed through fluid of one of the chambers from a first end thereof to accommodate a light emission toward a second opposite end of the one of the chambers; and
a prism coupled to the fiber optic line at a location closer to the second opposite end for directing a return light through the line and back toward the first end for obtaining a fiber optic reading of the one of the fluids through which the line is deployed.

2. The flow battery measurement system of claim 1 wherein the membrane chamber comprises a porous carbon structure.

3. The flow battery measurement system of claim 1 wherein the membrane chamber accommodates a membrane structure for electrolyte interaction between the fluids.

4. The flow battery measurement system of claim 1 wherein the flow battery comprises the chambers coupled to a power source for energy storage thereat.

5. The flow battery measurement system of claim 4 wherein the battery is a vanadium-based flow battery.

6. The flow battery measurement system of claim 1 further comprising a color sensor coupled to the fiber optic line at a location outside of the chambers.

7. The flow battery measurement system of claim 1 wherein the fiber optic line is a first fiber optic line deployed through a first one of the chambers, the system further comprising a second fiber optic line deployed through a second one of the chambers.

8. The flow battery measurement system of claim 1 wherein the prism is a first prism, the system further comprising a second prism coupled to the line at a location closer to the second opposite end for acquiring fluid level specific fiber optic readings from the line.

9. A flow battery measurement arrangement comprising:
a flow battery with fluid filled anode, cathode and membrane chambers;
a fiber optic line assembly deployed through at least one of the chambers, the assembly including a prism for receiving and returning fiber optic data from the at least one of the chambers; and
a signal conditioner assembly for acquiring the fiber optic data from the line assembly to establish one of a state of health and a state of charge for the battery.

10. The flow battery measurement arrangement of claim 9 wherein the signal conditioner assembly accommodates one of an optical spectrum analyzer and a signal processing unit for management of the acquired fiber optic data.

11. The flow battery measurement arrangement of claim 10 wherein the signal conditioner assembly accommodates a light source for directing light toward the prism.

12. The flow battery measurement arrangement of claim 11 wherein the signal conditioner assembly accommodates a reference light for directing a light toward one of the optical spectrum analyzer and the signal processing unit to support real-time calibration.

13. A method of measuring one of a state of health and state of charge for a flow battery, the method comprising:
deploying a fiber optic line assembly through a fluid of one of an anode, cathode and membrane chamber of the flow battery;
employing a prism coupled to the line assembly within the chamber to receive and return fiber optic light from the line assembly to a location outside of the chamber; and
collecting fiber optic data from the returned light indicative of the one of the state of health and charge for the battery.

14. The method of claim 13 further comprising:
flowing fluid through each of the chambers in a given direction;
sending the fiber optic light through the fiber optic line assembly toward the prism in a first direction that is one of with and against the given direction; and
returning the fiber optic light from the prism in a second direction opposite to that of the first direction.

15. The method of claim 13 further comprising analyzing the fiber optic data from the returned light to establish the one of the state of health and the state of charge.

16. The method of claim 15 further comprising establishing reference data for the fluid in advance of the analyzing of the data for enhancement thereof.

17. The method of claim 13 wherein the analyzing is employed to determine one of fluid temperature, impurities, color, bubbling and turbidity.

18. The method of claim 13 wherein the deploying of the line assembly is through one of the anode and cathode chambers to the exclusion of the other, the method further comprising extrapolating data regarding the other chamber based on data from the chamber in which the line assembly is deployed.

19. The method of claim 13 wherein the deploying of the line assembly comprises deploying a line assembly through multiple of the chambers for acquisition of fiber optic data from multiple chambers.

20. The method of claim 13 wherein the prism is a first prism and the line accommodates another prism at another depth within the chamber for acquisition of fiber optic data from multiple chamber depths.
